(19) United States
(12) Patent Application Publication
(10) Pub. No.: US 2009/0204422 A1
(43) Pub. Date: Aug. 13, 2009

(54) System and Method for Remotely Updating a Health Station

(76) Inventors: Terry L. James, Fairview, TX (US); Grant K. James, Fairview, TX (US)

Correspondence Address: Patent Capital Group, 6119 McCommas Blvd, Dallas, TX, 75214, US

(21) Appl. No.: 12/030,061

(22) Filed: Feb. 12, 2008

(51) Int. Cl. G06Q 50/00

(52) U.S. Cl. 705/2

(57) ABSTRACT

A method for remotely updating a health station is presented in one example embodiment. The method includes establishing one or more communication sessions between one or more health stations and a web server. The method includes receiving, at the one or more health stations, a user interface from the web server. The method includes loading the user interface by a host application stored on the one or more health stations.

### TECHNICAL FIELD OF THE INVENTION

This invention relates in general to health management and, more particularly, to a system and method for remotely updating a health station.

### BACKGROUND OF THE INVENTION

Most current health stations run static software, such that health stations can not be updated without incurring significant costs. As a result, health stations do not include modern user interfaces to display to user. Users will not be motivated to interact with health stations having an outdated user interface that displays the same static content each day. As a result, users will not be motivated to be active and healthy. Modern and dynamic user interfaces may incentivize users to interact with health stations, which in turn may motivate users to be healthy and active.

Additionally, health stations are not installed with new cutting edge hardware components for measuring biometric data or receiving health data. A healthcare operator may wish to install a new biometric collection device to health station, but operator may choose not to install the new biometric collection device because it may not be possible to update the software that controls the functionality of the biometric collection device. Similarly, user may wish to connect the latest activity monitor to health station. Health station may not be able to receive data from the latest activity monitor until the software is updated. As a result, user with the latest activity monitor may not be as active.

Even if the health stations can be updated, the software controlling the biometric collection device must be installed manually. This method may cause significant costs for distributing software to clients and incurring costs of having an expert travel to each health station having problems.

As the technology of user interfaces and biometric collection devices increase, efficiently updating health stations becomes even more critical. Some health stations may be so outdated that users are disincentivized to be healthy and active. Thus, the ability to remotely and quickly update health stations presents a significant challenge to healthcare operators.

### SUMMARY OF THE INVENTION

From the foregoing, it may be appreciated that a need has arisen for an improved process for updating health stations by providing a system operable to remotely update health stations. In accordance with the present invention, disadvantages and problems associated with previous techniques for updating software in a health station by offering a superior system.

In accordance with one embodiment of the present invention, a method for remotely updating a health station is presented in one example embodiment. The method includes establishing one or more communication sessions between one or more health stations and a web server. The method includes receiving, at the one or more health stations, a user interface from the web server. The method includes loading the user interface by a host application stored on the one or more health stations.

The one or more communication sessions may be initiated by the user interface stored on the one or more health stations. The loading of the user interface by a host application may include deleting an old user interface stored on the one or more health stations and loading the user interface received from the web server.

Important technical advantages of certain embodiments of the present invention include maximizing participant's user experience because the user interface and host application may be updated remotely in real time. As a result, user interfaces may be displayed to reflect new content daily, such as advertisements. Additionally, health stations can be outfitted with modern biometric collection devices and software that interacts with these new biometric collection devices can be updated remotely.

Other important technical advantages of certain embodiments of the present invention include transmitting data from a remote location to a health station protected by a secure network. Communication sessions may be initiated by health station, such that content can be delivered from remote server even if health station is protected by a firewall.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram that illustrates a system for remotely updating software in a health station;

FIG. 2 is a simplified flowchart that illustrates an example method for remotely updating user interface in a health station;

FIG. 3 is a simplified flowchart that illustrates an example method for remotely updating host application in a health station; and

FIG. 4 is a simplified flowchart that illustrates an example method for remotely restarting host application in a health station.

### DETAILED DESCRIPTION OF THE INVENTION

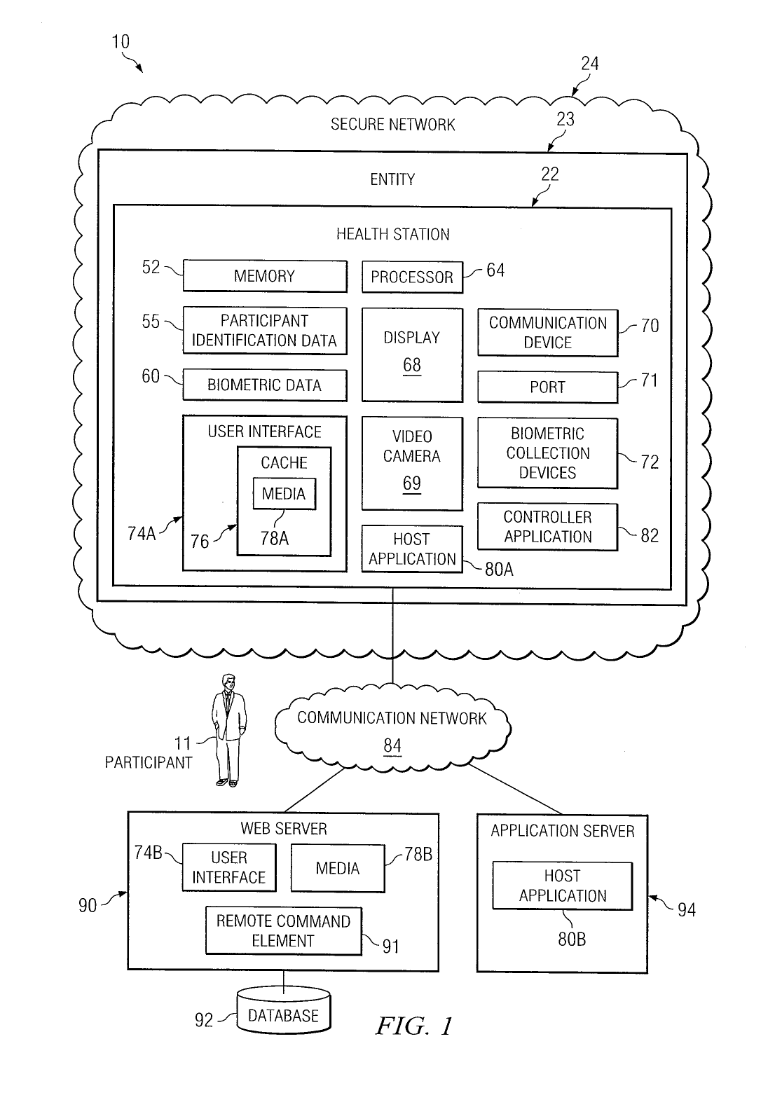

FIG. 1 is a simplified block diagram of a system 10 for remotely updating software in a health station. In one example, this is achieved via a web server 90, which is connected to a network. In another example, an application server 94 or other type of server may update software or control operations in health station.

According to the embodiment of FIG. 1, system 10 includes a participant 11, a health station 22, an entity 23, a secure network 24, a communication network 84, a web server 90, a database 92, and an application server 94. Health station 22 may also include a memory 52, participant identification 55, biometric data 60, a processor 64, a display 68, a video camera 69, one or more communication devices 70, a port 71, one or more biometric collection devices 72, a user interface 74A, a cache 76, media 78A, a host application 80A, and a controller application. Web Server 90 may include user interface 74B and media 78B. Application server 94 may include host application 80B. Note that many of these items could be removed from the current health station arrangements, as the example of FIG. 1 is providing a comprehensive solution that offers a myriad of potential choices. For example, some of the items could be simply removed to offer a streamlined version of the present solution.

In accordance with the teachings of one embodiment of the present invention, communication system 10 achieves an effective way for multiple health stations 22 to be updated from a remote location. This remote update can be performed at remote web server 90 for multiple health stations 22.

In contrast to the architecture of the present disclosure, current health stations are not capable of being updated remotely as described in this disclosure. In essence, new emerging technology is being incorporated into a health system in the present invention. The architecture behind the concept allows for real time updates to multiple health stations from a remote location, such that health station 22 never goes offline.

Software and/or hardware may reside in health station 22, and/or user interface 74, and/or host application 80, and/or controller application 82, and/or web server 90, and/or application server 94 in order to achieve the teachings of the features of the present invention. Note that, due to their flexibility, these components may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of health station 22, and/or user interface 74, and/or host application 80, and/or controller application 82, and/or web server 90, and/or application server 94 in the context of system 10 and, accordingly, they should be construed as such.

It should be noted that the internal structure of the system of FIG. 1 is versatile and can be readily changed, modified, rearranged, or reconfigured in order to achieve its intended operations or additional operations. Additionally, any of the items within FIGS. 1-4 may be combined, where appropriate, or replaced with other functional elements that are operable to achieve any of the operations described herein.

While system 10 is aimed at remotely updating software on a health station, the architecture lends itself to important benefits in a healthcare environment. For example, because the software of health station 22 may be updated remotely, health station 22 may be updated more frequently with the newest technology, health literature, and/or biometric devices. As a result, participant 11 receives an interactive and enlightening experience that is related to participant's health.

The present invention does utilize some technology previously applied for by Applicant. Note that the following related cases, which address aspects of a website, healthcare methodologies, and features of end user devices, are hereby incorporated by reference: Accelerometer for Data Collection and Communication, Ser. No. 10/996,500, filed Nov. 23, 2004; System and Method for Implementing an Interactive Online Community Utilizing an Activity Monitor, Ser. No. 11/625,063, filed Jan. 19, 2007; System and Method for Population Health Management Data Collection and Communication: Ser. No. 10/915,852, filed Aug. 11, 2004; and System and Method for Modifying Risk Factors By a Healthcare Individual at a Remote Location: Ser. No. 11/760,457, filed Jun. 8, 2007.

According to the illustrated embodiment, system 10 provides services such as communication sessions to endpoints, such as health station 22, web server 90, and application server 94. A communication session refers to an active communication between endpoints. Information may be communicated during a communication session. Information may include voice, data, text, audio, video, multimedia, control, signaling, and/or other information. Information may be communicated in packets, each comprising a bundle of data organized in a specific way for transmission. Communication sessions are discussed in more detail below detailing how user interface 74 and host application 80 communicate.

One advantage of an embodiment of the present invention is the way that communication sessions are established. Health station 22 may periodically send out a signal to web server 90. Signal may include data such as the version of user interface 74A, the version of host application 80A, and data indicating if the health station 22 is alive or dead. Web server 90 may respond with data sent across communication session to health station 22. Similarly, health station may send a signal to application server 94 and application server 94 may send an updated host application 80 across communication session to health station 22. In an alternative embodiment, web server 90 may initiate the communication session by sending out updated files to health stations 22. However, this scenario may not work if health station 22 is behind a firewall.

System 10 may utilize communication protocols and technologies to provide communication sessions. Examples of communication protocols and technologies include those set by the Institute of Electrical and Electronics Engineers, Inc. (IEEE) standards, the International Telecommunications Union (ITU-T) standards, the European Telecommunications Standards Institute (ETSI) standards, the Internet Engineering Task Force (IETF) standards (for example, IP such as mobile IP), or other standards.

According to the illustrated embodiment, participant 11 represents any individual who utilizes health station 22. Additionally, participant 11 may visit health station 22 to measure biometric data 60 through biometric collection devices 72. Participant 11 can also dock activity monitor with health station 22, such that participant 11 can upload and view activity data. Participant 11 may have a unique website associated with activity monitor that is displayed on health station 22. In another embodiment, participant 11 may be an employee who is required by employee's employer to visit health stations 22. In another embodiment, participant 11 may be an individual in a nursing home who is required to visit health station 22 on a periodic basis. In another embodiment, participant 11 may be a student who is required to dock activity monitor as part of a physical education curriculum.

According to illustrated embodiment, health station 22 represents any suitable device operable to collect biometric data 60 from participant 11 and display content via user interface 74A. Health station 22 may represent a computer, server or data processing system, depending on context and applicable tasks. In the current embodiment, health station 22 may be located within an entity 23. Health station 22 may also include a memory 52, participant identification 55, biometric data 60, a processor 64, a display 68, a video camera 69, one or more communication devices 70, a port 71, one or more biometric collection devices 72, a user interface 74A, a cache 76, media 78A, a host application 80A, and a controller application. Health station 22 may be constructed from any material with any suitable design.

For example, health station 22 may be constructed from wood in the shape of a bench seat, including a monitor, a telephone, a video camera, and a weight scale, such that the weight scale is positioned under the seat so that participant can measure weight while sitting. In another embodiment, health station 22 may be constructed from metal in the shape of a rectangular box, including a monitor, built in speaker, and built in microphone. Health station may utilize display 68 and user interface 74A to create an enjoyable experience for participant. User interface 74A may be customized for participants based on participant identification data 55. User interface 74A may be updated in real time from web server 90 to update health station 22 with customizable media content to be displayed. Health station 22 may display content of any type via user interface 74A, such as a web site, an advertisement, streaming video, or a pre-recorded video session to participant 11 from a healthcare individual. Health station 22 may be updated with a new user interface 74A from web server 90, such that web server 90 may update several health stations 22 located remotely throughout different geographic regions. User interface 74A is discussed in greater detail below.

Health station 22 may capture a multitude of data. For example, health station 22 may capture participant's name, risk factors, health risk appraisal data, biometric data 60, utilization data, medical records, health insurance enrollment data and any other relevant data. Health station 22 may save data associated with each participant 11 on a web server 90 or database 92, such that health station 22 will have participant's information on subsequent visits based on participant identification data 55. Health station 22, including biometric collection devices 72 and electronic intervention modules, may be customized and configured by authorized individuals, such as healthcare individuals. For example, entity ABC may configure their health station 22 so that health station 22 displays participant's website when activity monitors are connected to health station 22.

In another example, health station 22 may need to update its software when a new biometric collection device 72 is installed. Host application 80A may control the functions of hardware, such that host application 80A may need to be updated to achieve these customizations. Health station 22 may be updated with a new host application 74A from application server 94, such that application server 94 may update several health stations 22 located remotely throughout different geographic regions. Software such as host application may be updated to interact with a newly developed biometric collection device.

In one embodiment of the present invention, manual installation is no longer required to update host application 80A for each health station 22 that includes a newly installed biometric collection device 72. Instead, application server 94 may automatically send out this updated version of the host application that is associated with the new biometric collection device 72 to all of the health stations 22 that have installed the new biometric collection device 72. Host application 80A is discussed in greater detail below. Other architectures and components of health station 22 may be used without departing from the scope of this disclosure.

Entity 23 may be any business, school, commerce, or public location where health station 22 or computing device is located. Entity 23 may include a company, a university, a residence, an elementary school, a nursing home, a grocery store, a gym, etcetera. For example, a company may use health station 22 to lower costs and increase productivity from employees. Employees at company may visit health station 22 rather than a doctor's office when employee is feeling sick, which may provide employee with an immediate health management and minimize the time employee is away from work.

Participant 11 may be employee at company may also visit health station 22 to participate in risk modification interventions for general health risk, such as weight management and risk factors specific for heart disease, such as lowering a participant's LDL. Note that user interface displayed on health station 22 for participant 11 may be a website that is associated with participant 11. For example, the user interface may display a website associated with the participant identification data 55 and maintain a healthcare profile for participant 11 that includes biometric data 60 and other health data. Participant 11 may have customized settings of how content on website is displayed.

Secure network 84 may comprise an enterprise intranet with a firewall. Secure network 84 may provide an extra layer of security to health station 22 or entity 23 from information incoming from communication network 84. Firewall of secure network 24 may prevent data from reaching health station 22 that is protected by the firewall. Therefore, a remote server 90, 94 may not be able to transmit a file to health station 22 protected by a secure network 24 with a secure firewall. One advantage of the present invention overcomes this obstacle in the way that communication sessions are established. Health station 22 may periodically send out signal to web server 90. Signal may include data such as the version of user interface 74A, the version of host application 80A, data indicating if health station 22 is alive or dead, etcetera.

Memory 52 may be located in health station 22, web server 90, application server 94, and/or database 92. Memory 52 accessed or otherwise utilized by one or more components of health station 22, web server 90, application server 94, or database 92. Memory 52 may take the form of volatile or non-volatile memory including, without limitation, magnetic media, optical media, random access memory (RAM), read-only memory (ROM), removable media, or any other suitable local or remote memory component. In general, memory 52 may store various data including participant's identification data 55, health data, user interface 74A, media 78A, host application 80A, and controller application 82.

Participant identification data 55 may be stored on health station 22 and/or server 80. Participant identification 55 is used by health station 22 and server 80 to store and update health data 56 associated with participant 11. Participant identification 55 can be obtained from a card reader, fingerprint scanner, or any other well-known software or hardware authentication system. In one particular embodiment, health station 22 and server 80 can recognize participant's identification 55 from participant's activity monitor connected to health station 22. Alternatively, health station 22 may prompt participant 11 for participant identification and password. Each participant 11 can receive a personalized experience with customized settings stored in memory associated with participant's identification 55.

As used herein, biometric data 60 reflects measured health information that is not necessarily self-reported. This information may be gathered from (or relate to) participant 11 and generally reflects physical data, which is measured. In this particular embodiment, health station 22 is operable to measure participant's biometric data 60, including blood pressure, pulse, glucose levels, weight, air flow, etcetera. Health station 22 may collect detailed measurements of biometric data 60. For example, health station 22 may collect detailed measurements related to heart pressure, such as systolic pressure, diastolic pressure, and heart rate. Biometric data 60 may relate to diagnostic information that could be provided in a laboratory report or gathered, for example, during the course of a magnetic resonance imaging (MRI) scan, in the context of evaluating an employee, or in performing some type of lab work or blood-work.

In other scenarios, biometric data 60 may involve assessing body fat and blood cholesterol, lung capacity (e.g. using a flow meter), height, density and weight measurements, or any other suitable test or evaluation that yields some tangible result for an examining healthcare individual. In still other embodiments, this could include testing (e.g. psychiatric evaluations) that involves questionnaires, inkblot tests, etc. Alternatively, biometric data 60 may include any other suitable physical measurement, dimension, relevant health fact, parameter, or piece of data that may be collected by a physician, nurse, or representative authorized to do so. Additionally, system 10 may associate the biometric data 60 collected and store this data with the medical utilization data for a particular participant.

Processor 64 may be located in health station 22, web server 90, and application server 94. Processor 64 may control each device by processing information and signals. Processor 64 includes any suitable hardware, software, or both that operate to control and process signals. Processor may be microprocessors, controllers, or any other suitable computing devices, resources, or combination of hardware, software and/or encoded logic. In one particular embodiment, processor may be operable to intelligently select intervention modules based on participant's health data. In a particular embodiment, processor 64 in health station 22 may be operable to receive user interface updates from web server 90, such as software, module, and website updates. Additionally, health station 22 may receive new software, such as host application 80, from application server 94 for measuring biometric data from a new biometric collection device, such that an individual does not have to make software changes to each health station 22 at a remote location.

Display 68 on health station 22 may be operable to display one or more images in one or more formats. User interface 74A viewed on display 68 may include websites, streaming video, advertisements, digital photographs, or any other suitable media. For example, participant 11 may view website associated with participant's health data and an embedded window within website that streams a live video of healthcare individual. In another embodiment, display 68 can be a touch screen, such that participant 11 will have a more interactive experience. Since display 68 may be a touch screen, participant 11 can interact with health station 22 without a mouse or keyboard.

Video camera 69 on health station 22 and access terminal 90 may be operable to stream live video of participant 11 across network 84. Additionally, video camera 69 is operable to take digital photographs and transmit digital photograph across network 84. For example, on initial visit to health station 22, participant 11 may take photograph from video camera 60 for participant's personalized webpage. Participant 11 may then connect to a live video feed with healthcare individual, such that participant 11 and healthcare individual may see and speak with one another in essentially real time to provide a personal one on one experience.

Communication devices 70 on health station 22 may be operable to facilitate communication. For example, communication devices 70 may include a microphone, speaker, keyboard, mouse, etc. Communication devices 90 may be internal to health station 22 or access terminal 90 or communication devices 90 may be an auxiliary device attached to health station 22 or access terminal 90.

Participant 11 at health station 22 may have two-way live communication with one or more end users in system 10. For example, this communication may be from one health station 22 to any end point in system 10, such as two-way communication from one health station 22 to another health station 22 or health station 22 to a personal computer. To carry out this two-way live communication, one or more methods and devices may be used, including webcams communicating streaming video, microphone communicating audio data, and/or keyboard communicating electronic text.

Port 71 on health station 22 may be operable for any electronic device to communicate with health station 22 and network 84. In one particular embodiment, participant 11 can log into health station 22 by connecting activity monitor to port 71. Health station 22 may then automatically upload participant's website and participant's personal data. In another embodiment, participant 11 may upload digital photographs from a digital camera to memory in health station 22 or web server 90, such that participant 11 connects digital camera to port 71.

Biometric collection devices 72 on health station 22 are operable to measure and store participant's biometric data 60 in memory 52. Biometric collection devices 72 can measure blood pressure, pulse, glucose levels, weight, airflow, etcetera. Biometric collection devices 72 are also operable to store data in memory 52 and transmit collected biometric data to health station 22, web server 90, and/or database 92. In one particular embodiment, participant 11 may place arm in cuff attached to health station 22, such that cuff measures participant's blood pressure. Blood pressure cuff may collect detailed measurements related to blood pressure, such as participant's systolic pressure, diastolic pressure, and heart rate. In another embodiment, participant 11 may sit down and place feet on bar positioned under the seat of health station 22, such that bar accurately measures participant's weight. In another embodiment, participant 11 may step on a traditional weight scale attached to health station 22, such that scale accurately measures participant's weight. Biometric collection devices 72 allow for healthcare individuals 92 to receive biometric data 60 and provide an immediate intervention plan to participant 11 located at remote health station 22. Host application 80A may contain logic such that biometric collection devices 72 operate correctly. Host application 80A may contain logic that measures and stores biometric data 60 from biometric collection devices 72. When a new biometric collection device 72 is installed on health station 22, host application 80A may need to be updated before the new biometric collection device 72 is operational.

User interface 74 (74A, 74B) may be logic and/or software that may present graphical, textual, and/or auditory information to participant 11. User interface 74 may be a FLASH player, a web browser, or any software operable to present graphical, textual, and/or auditory information to participant 11. When displayed, user interface 74 may be a web site customized to participant 11. For example, user interface 74 may display participant's personal information, such as website associated with participant's names, pictures, friends, and graphs associated with participant's activity, health, and biometric data 60. Logic in user interface 74 may contain instructions to load user interface 74 with media 78. Logic in user interface 74 may instruct health station 22 to download media from web server 90 or other location on communication network 84.

A copy of an updated user interface 74B may be stored at a remote web server 90. One or more copies of updated user interface 74B may be transmitted to one or more remote health stations 22. A copy of an updated user interface 74A may be transmitted, loaded, and stored in health station 22. User interface 74A on health station may be deleted and then loaded with a new updated user interface 74A such that controller application 82 never restarts. Because health station 22 remains alive while controller application 82 is alive, several potential problems are avoided by allowing user interface 74A to be updated without shutting down health station 22.

For example, an operator may own over one hundred health stations 22 located across multiple geographic areas. If operator ever desires for health stations 22 to display new content that is not already identified in user interface 74, then user interface must be updated to incorporate the new content to be displayed by health stations 22. In the past, in order to update a user interface 74, the updated user interface 74 may have been manually installed on each health station.

According to an embodiment of the present invention, user interface 74B may be updated and stored at a centralized web server 90. Web server 90 may transmit this updated user interface to multiple health stations 22 located in different geographic areas. One advantage of an embodiment of the present invention is the way that communication sessions are established for transmitting updated user interface 74 and media 78. User interface 74 may periodically send out a signal to web server 90. Signal may include data such as the version of user interface 74A, the version of host application 80A, and data indicating if the health station 22 is alive or dead. Web server 90 may store a log of these records associated with each health station 22 in database 92. This may allow web server 90 to know which health station 22 is alive or dead and what version of user interface 74A and host application 80A is currently loaded on each health station 22. Web server 90 may utilize this information to respond to signal from health station 22 with an updated version of user interface 74 or host application 80 that is sent across communication session to health station 22. In one embodiment, communication sessions may occur through HTTP request through port eighty. Other requests and ports may be used in other embodiments. In an alternative embodiment, web server 90 may initiate the communication session by sending out updated user interface 74 to health stations 22. However, this alternative embodiment may not achieve a desirable result if health station 22 is behind a firewall.

Cache 76 may be a block of memory for temporary storage of data likely to be used again. Cache 76 may be a temporary storage area where frequently accessed data can be stored for rapid access. Once media 78 is stored in cache 76, future use of media 78 may be made by accessing the cached copy rather than re-fetching or recomputing the original data, so that the average access time is shorter. Cache may expedite data access that processor would otherwise need to fetch from memory. Health station 22 may store media 78 in cache to increase the speed and efficiency of displaying user interface.

In another embodiment, media 78 and other data may be stored at a remote location, such that media 78 and data are not stored locally on health station 22. Health station 22 may access media 78 with requests to the remote location.

Media 78 (78A and 78B) may be any electronic data associated with audio or visual content. Media 78 may be a SWF file, text, an image, an mp3 file, an html file, a music file, php script, asp, a streaming video, an audio stream, etcetera. Media 78B may be stored on web server 90 that is transmitted to cache 76 at each health station 22 so that media 78A stored on cache may be quickly loaded into user interface 74.

Host application 80 (80A and 80B) may be logic and/or software that performs some task associated with updating and loading user interface 74. In one particular embodiment, host application 80 may be software written in Visual Basic. Other suitable programming languages may be used in other embodiments such as C++. Host application 80 may send signal to web server to update media. Web server 90 may then transmit media 78 associated with the updated user interface 74 to health station 22. Host application 80A may communicate with user interface 74A to check if user interface 74A is still running. If user interface 74A is not running, host application 80A may reload current version of user interface 74A.

Additionally, host application 80 may be logic and/or software that performs some task associated with hardware 74 installed on health station 22 or hardware that interacts with health station 22. For example, host application 80 may be responsible for communicating with one or more biometric collection devices 72 when participant 11 interacts with health station 22. Host application 80 may control biometric collection device 72, obtain biometric data 60 associated with participant 11 interacting with biometric collection device 72, and transmit this biometric data 60 to web server and/or database 92 for storage. As a result, when new biometric collection device 72 is installed on health station 22, host application 80 may be updated to successfully control the new biometric collection device 72, obtain biometric data 60 associated with participant 11 interacting with biometric collection device 72, and transmit this biometric data 60 to web server 90 and/or database 92 for storage. Additionally, host application 80 may also be responsible for hardware interacting with health station 22. For example, when participant 11 uses activity monitor to log into health station 22, host application 80 may communicate with activity monitor to obtain data from activity monitor, such as participant identification data 55, activity data, and health data. As a result, when a new version of activity monitor is released, host application 80 may need to be updated in order to successfully obtain data from the new version of activity monitor.

A copy of an updated host application 80B may be stored at an application server 94. One or more copies of updated host application 80B may be transmitted to one or more remote health stations 22. A copy of an updated host application 80B may be transmitted, loaded, and stored in health station 22. Host application 80A on health station may be deleted and then loaded with a new updated host application 80A such that controller application 82 never restarts. Because health station 22 remains alive while controller application 82 is alive, several potential problems are avoided by allowing host application 80A to be updated without shutting down health station 22.

For example, an operator may own over one hundred health stations 22 located across multiple geographic areas. If operator ever desires for health stations 22 to be installed with new biometric collection devices 72 that are not already identified in host application 80, then host application 80 must be updated to incorporate the newly installed biometric collection devices to correctly record biometric data by health stations 22. In the past, in order to update a host application 80, the updated host application 80 may have been manually installed on each health station 22.

According to an embodiment of the present invention, host application 80B may be updated and stored at a centralized web server 90. Web server 90 may transmit this updated host application 80 to multiple health stations 22 located in different geographic areas. One advantage of an embodiment of the present invention is the way that communication sessions are established for transmitting updated host application 80. User interface 74 may periodically send out a signal to web server 90. Signal may include data such as the version of user interface 74A, the version of host application 80A, and data indicating if the health station 22 is alive or dead. Web server 90 may store a log of these records associated with each health station 22 in database 92. This may allow web server 90 to know which health station 22 is alive or dead and what version of user interface 74A and host application 80A is currently loaded on each health station 22. Web server 90 may utilize this information to respond to signal from health station 22 with a command to update host application 80. As a result of receiving the command to update host application 80, health station 22 may run software and/or logic that sends a signal to application server 94 to download updated host application 80. This software and/or logic may compare the version of currently loaded host application 80A to the version of host application 80B stored on application server 94 to determine if download should occur. Updated host application 80 may then be sent across communication session to health station 22. In one embodiment, communication sessions may occur through HTTP request through port eighty. Other requests and ports may be used in other embodiments. In an alternative embodiment, web server 90 may instruct the application server 94 to initiate the communication session by sending out updated host application 80 to health stations 22. However, this alternative embodiment may not achieve a desirable result if health station 22 is behind a firewall.

Controller application 82 may be logic and/or software that performs some task associated with updating and loading host application 80A. In one particular embodiment, controller application 82 may be software written in Visual Basic. Other suitable programming languages may be used in other embodiments such as C++. Controller application 82 is running when user interface 74A and host application 80A are updated or restarted. Controller application 82 may communicate with host application 80A to check if host application is still running. If host application 80A is not running, controller application 82 may reload current version of host application 80A. Controller application 82 allows for web server to transmit an updated host application 80A to health station 22 remotely because controller application continuously runs and controls loading an updated host application. Controller application 82 may be remotely updated from web server 90 by using FTP calls.

For example, when an operator or web server 90 decide to update health stations 22 with an updated host application 80 because a new weight scale was installed on health stations 22, web server 90 or operator at a remote machine may transmit the updated host application 80 to each health station 22 to be updated. Health station 22 communicates to controller application 82 to update host application 80. Controller application 82 deletes the current host application 80 loaded on health station 22, and controller application 82 loads the new host application 80 on health station 22. Controller application 82 continues to run without shutting down during this entire process. This has several advantages including the benefit of conveniently rolling back to an earlier version of host application 80 or correcting current version of host application 80 if updated host application 80 causes bugs or doesn't load properly in health station 22. Because controller application 82 is always running, web server 90 may transmit an older version (or debugged version) of host application 80 to health station 22 even if the updated host application 80 causes problems.

In one embodiment, any file or application on health station 22 may be updated. For example, medical records of participant stored on health station 22 may be updated from a remote location. Similarly, medical records of participant 11 stored at a remote location may also be updated.

In one embodiment, user interface 74A, host application 80A, controller application 82, or any application can be installed or uninstalled at health station 22 from a remote location by the operator or by web server 90. Additionally, health station 22 may be restarted from a remote location by the operator or by web server 90. Health station 22 may also be remotely controlled from a remote location by the operator or by web server 90.

The architecture of health station 22 that includes the user interface 74A, host application 80A, and controller application 82 are an advantage of the present invention. Each of these elements has a specialized role within health station 22. Controller application 82 ensures that user interface 74 and host application 80 may be updated without control application having to restart. As a result, host application 80 can be modified and updated remotely. Additionally, user interface 74 can be modified and updated remotely. As new technology and hardware come along, the architecture of these elements within health station 22 allow for health station 22 to be updated continously from a remote location, such as web server 90. As a result, operator saves time and money from having to manually install new software on health stations 22. Other new applications not presented in this disclosure may be loaded on health station 22 as well, such that an updated host application 80 may contain new instructions to load these new applications. As a result, software on health station 22 may be changed dynamically and remotely for any present or future applications.

It is critical to note that health station 22, user interface 74A, and host application 80A may include any suitable elements, hardware, software, objects, or components capable of effectuating their operations or additional operations where appropriate. Additionally, any one or more of the elements included in health station 22 and user interface 74A may be provided in an external structure or combined into a single module or device where appropriate. Additionally, any one or more of the elements included in health station 22 and host application 80A may be provided in an external structure or combined into a single module or device where appropriate. Moreover, any of the functions provided by health station 22 and user interface 74A may be offered in a single unit or single functionalities may be arbitrarily swapped between health station 22 and user interface 74A. Additionally, any of the functions provided by health station 22 and host application 80A may be offered in a single unit or single functionalities may be arbitrarily swapped between health station 22 and host application 80A. Additionally, and of the functions provided by web server 90 and application server 94 may be offered in a single unit or single functionalities may be arbitrarily swapped between web server 90 and application server 94. The embodiment offered in FIGURE 1 has been provided for purposes of example only. The arrangement of elements (and their associated operation(s)) may be reconfigured significantly in any other appropriate manner in accordance with the teachings of the present disclosure.

System 10 includes a communication network 84. In general, communication network 74 may comprise at least a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication links, or any combination of any of the preceding.

Web server 90 may include a remote command element 91, which allows for the operator to perform certain commands remotely to health stations 22, such as update host application 80, restart host application 80, update user interface 74, restart health station 22, etcetera. Web server 90 may automatically respond to signal from health station 22 to perform these commands. The command to update host application 80 allows for web server 90 to remotely update the host application 80 running on multiple health stations 22. The command to update user interface 74 allows for web server 90 to remotely update user interface 74 running on multiple health stations 22. The command to restart host application 80 allows for web server 90 to remotely restart host application 80 running on multiple health stations 22.

Remote command element 91 may be logic and/or software that performs some task associated with remotely communicating with one or more health stations 22. In one embodiment, remote command element 91 may be a web page that can only be accessed by an authorized operator. Remote command element 91 may display the health station identification, the date health station 22 was registered, the date and time of the most recent communication received from health station 22, the date and time of the most recent update to health station 22, the user interface 74A version on health station 22, the host application 80A version on health station 22, the controller application 82 version on health station 22. Additionally, remote command element 91 may display any useful information to operator, such as if health station is online or offline.

Remote command element 91 may be operable for operator to send commands to one or more health stations 22, such as restarting health station 22, updating a file on health station 22, installing an application on health station 22, uninstalling an application on health station 22, updating user interface 74 on health station 22, updating host application 80 on health station 22, updating controller application 82 on health station 22, etcetera.

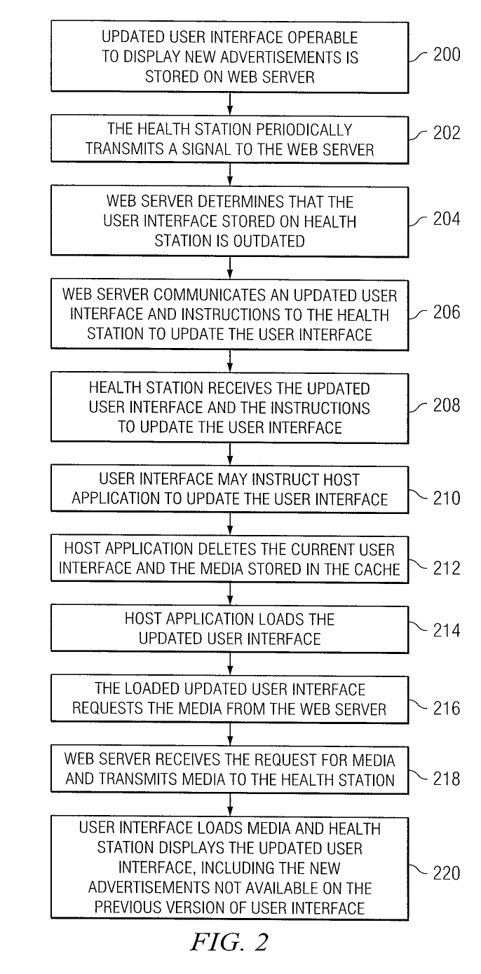

For example, if health station 22 sends a signal to web server 90 indicating that health station 22 currently runs user interface version 4.3.3, then web server 90 may check this version against the current user interface version stored on web server 90. If current user interface version is newer than version 4.3.3, then web server 90 may perform command to update user interface 74 by responding to the signal sent by health station 22. By responding to signal from health station 22, web server 90 may form a communication session with health station 22, such that user interface 74 and media 78 transmitted by web server 90 can reach health stations 22 behind a firewall on secure network 24. Similar techniques for remotely updating user interface on health stations 22 by web server 90 are used for remotely updating host application 80 and restarting host application 80. The commands and processes associated with web server 90 updating user interface, updating host application, and restarting host application are described in more detail in FIGS. 2-4.

In other embodiments, web server 90 may be triggered to respond to signal from health station 22 with one of the commands or processes, such that operator can decide what causes the triggering event. In other embodiments, operator of web server 90 may use remote command element 91 to send a command to update host application 80, restart host application 80, restart health station 22, update user interface 74, etcetera.

Web server 90 may also be operable to store data. In some embodiments, one or more web servers 90 may be physically distributed such that each web server 90, or multiple instances of each web server 90, may be located in a different physical location geographically remote from each other. In other embodiments, one or more web servers 90 may be combined and/or integral to each other. One or more web servers 90 may be implemented using a general-purpose personal computer (PC), a Macintosh, a workstation, a UNIX-based computer, a server computer, or any other suitable processing device.

Web server 90 may also be operable to communicate with health station 22 and/or elements loaded on health station 22 and/or database 92. Web server 90 may receive communications from health stations 22 and/or applications loaded on health stations 22. Additionally, web server 90 may communicate with health stations 22 and/or applications loaded on health stations 22, such as transmitting data to health stations 22. For example, web server 90 may transmit updated user interface 74 and media 78 to health stations 22. Operator of web server only have to store one copy of updated user interface 74B and media 78B on remote web server 90 and/or backup server. As a result, operator of web server 90 may remotely update health stations 22 with updated user interface 74B and media 78B stored on web server 90.

Database 92 may be operable to store various data associated with participant 11 and health station 22, such as information regarding participants 11, biometric data 60, biometric collection devices 72, user interface 74, host application 80, controller application 82, activity monitor data, status logs of health stations, etcetera. Database 92 may associate a particular health station 22 with the current hardware and software loaded on health station 22. Database 92 may associate a particular individual with health data, biometric data, and customized settings for display of user interface. Databases 34 may communicate with web server 90 and application server 94 such that web server 90 and application server 94 may store information, retrieve information, and share information with each other. Databases 34 may provide a backup in the case of outages or other failures of various components of web server and/or application server.

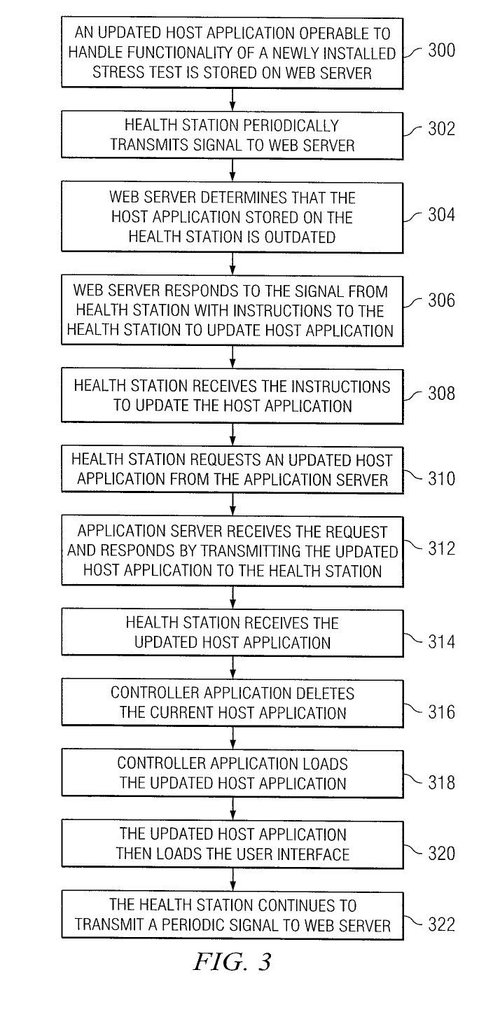

Application server 94 may have an interface or application for operator to perform certain commands remotely to health stations 22, such as update host application, restart host application, etcetera. Application server 94 may automatically respond to signal from health station 22 to perform these commands. For example, if health station 22 sends a signal to application server 94 indicating that health station 22 currently runs host application version 5.2.1, then application server 94 may check this version against the current host application 80 version stored on application server 94. If current host application version is newer than version 5.2.1, then application server 94 may perform command to update host application 80 by responding to the signal sent by health station 22. By responding to signal from health station 22, application server 94 may form a communication session with health station 22, such that host application 80 transmitted by application server 94 can reach health stations 22 behind a firewall on secure network 84. The commands and processes associated with application server 94 updating host application are described in more detail in FIG. 3. In other embodiments, application server 94 may be triggered to respond to signal from health station 22 with one of the commands or processes, such that operator can decide what causes the triggering event. In other embodiments, operator of application server 94 may initiate a command to update host application.

Application server 94 may also be operable to store data. In some embodiments, one or more application servers 94 may be physically distributed such that each application server 94, or multiple instances of each application server 94, may be located in a different physical location geographically remote from each other. In other embodiments, one or more application servers 94 may be combined and/or integral to each other. One or more application servers 94 may be implemented using a general-purpose personal computer (PC), a Macintosh, a workstation, a UNIX-based computer, a server computer, or any other suitable processing device.

Application server 94 may also be operable to communicate with health station 22 and/or elements loaded on health station 22 and/or database 92. Application server 94 may receive communications from health stations 22 and/or applications loaded on health stations 22. Additionally, application server 94 may communicate with health stations 22 and/or applications loaded on health stations 22, such as transmitting data to health stations 22. For example, application server 94 may transmit updated host application 80 to health stations 22. Operator of application server 94 only have to store one copy of updated host application 80 on remote application server 90 and/or backup server. As a result, operator of application server 94 may remotely update health stations 22 with updated host application 78B stored on application server 94.

FIG. 2 illustrates an example method for remotely updating user interface in a health station in accordance with one embodiment of the present invention. At step 200, operator may decide to update the user interface operable to display new advertisements. Operator implements these updates into a new updated user interface stored on the web server.

At step 202, the health station periodically transmits a signal to the web server. Signal may contain information such as the version of the user interface, the version of host application, and data indicating if the health station is alive or dead.

At step 204, web server analyzes signal from the health station and determines that the user interface stored on health station is outdated from the updated user interface version stored on web server. At step 206, web server communicates an updated user interface and instructions to the health station to update the user interface.

At step 208, health station receives the updated user interface and the instructions to update the user interface. At step 210, user interface may instruct host application to update the user interface. At step 212, host application deletes the current user interface and the media stored in the cache. At step 214, host application loads the updated user interface. At step 216, the loaded updated user interface requests the media from the web server. At step 218, web server receives the request for media and transmits media to the health station. At step 220, user interface loads media and health station displays the updated user interface, including the new advertisements not available on the previous version of user interface.

FIG. 3 illustrates an example method for remotely updating host application in a health station in accordance with one embodiment of the present invention. At step 300, operator may decide to install a new stress testing biometric collection device on health stations. Operator creates a new updated host application to handle the functionality associated with the new stress testing hardware installed on the health stations. Operator stores the new updated host application on application server.

At step 302, health station periodically transmits signal to web server. Signal may contain information such as the version of the user interface, the version of host application, and data indicating if the health station is alive or dead.

At step 304, web server analyzes the signal from the web server and determines that the host application stored on the health station is outdated from the updated version stored on the application server. At step 306, web server responds to the signal from the health station with instructions to the health station to update the host application.

At step 308, health station receives the instructions to update the host application. At step 310, health station requests an updated host application from the application server. Host application or controller application may communicate with the application server. At step 312, application server receives the request and responds by transmitting the updated host application to the health station.

At step 314, health station receives the updated host application. At step 316, controller application deletes the current host application. At step 318, controller application loads the updated host application. At step 320, the updated host application loads and updated host application then loads the user interface. At step 322, the health station continues to transmit a periodic signal to web server, such that signal includes the version of the updated host application installed.

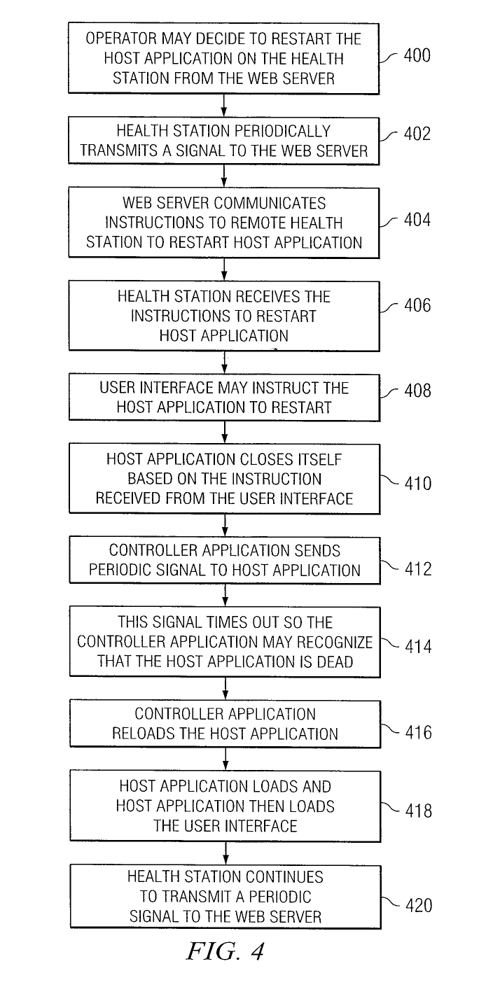

FIG. 4 illustrates an example method for remotely restarting host application in a health station in accordance with one embodiment of the present invention. At step 400, operator may decide to restart the host application on the health station because the health station was performing abnormally. Operator can instruct the web server to send instructions to restart the host application at the faulty health station upon receiving the next signal from the faulty health station.

At step 402, health station periodically transmits a signal to the web server. Signal may contain information such as the version of user interface, the version of host application, and data indicating if the health station is alive or dead.

At step 404, web server analyzes the signal from the web server, and web server communicates instructions to remote health station to restart host application.

At step 406, health station receives the instructions to restart host application. At step 408, user interface may instruct the host application to restart. At step 410, host application closes itself based on the instruction received from the user interface.

At step 412, controller application sends periodic signal to host application. At step 414, the signal times out so the controller application may recognize that the host application is dead. At step 416, controller application reloads the host application. At step 418, host application loads and host application then loads the user interface. At step 420, health station continues to transmit a periodic signal to the web server.

It is important to note that the stages and steps described above in the preceding FIGURES illustrate only some of the possible scenarios that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within health station to effectuate the tasks and operations of the elements and activities associated with executing compatibility functions.

Certain features of the invention have been described in detail with reference to particular embodiments in FIGS. 1-4, but it should be understood that various other changes, substitutions, and alterations may be made hereto without departing from the sphere and scope of the present invention. For example, although the preceding FIGURES have referenced a number of relevant health risk factors, any suitable characteristics or relevant parameters may be readily substituted for such elements and, similarly, benefit from the teachings of the present invention. These may be identified on a case-by-case basis, whereby a certain participant may present a health risk factor while another (with the same condition) may not. Thus, a statistical relevance may be identified for one group, but not another who appears to be similar. Additionally, different and unique intervention plans can be customized by healthcare individuals and/or servers.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method, comprising:
establishing one or more communication sessions between one or more health stations and a web server;
receiving, at the one or more health stations, a user interface from the web server; and
loading the user interface by a host application stored on the one or more health stations.

2. The method of claim 1, wherein the one or more communication sessions are initiated by the one or more health stations.

3. The method of claim 2, wherein the one or more communication sessions initiated by the one or more health stations allow the one or more health stations to receive the user interface from the web server if the one or more health stations are located within a secure network comprising a firewall.

4. The method of claim 2, wherein the one or more communication sessions are initiated by the user interface stored on the one or more health stations.

5. The method of claim 1, wherein the loading the user interface by a host application comprises:
deleting an old user interface stored on the one or more health stations; and
loading the user interface received from the web server.

6. The method of claim 1, wherein the loading the user interface by the host application allows the one or more health stations to run continuously without shutting down.

7. The method of claim 1, wherein the user interface is a selected one of group of user interfaces, the group consisting of:
a) a FLASH player; and
b) a web browser.

8. The method of claim 1, further comprising:
receiving, at the one or more health stations, media from the web server; and
displaying the user interface and the media on the one or more health stations.

9. The method of claim 8, wherein the media is a selected one of group of media, the group consisting of:
a) a swf flash file;
b) an html file;
c) php;
d) asp;
e) javascript; and
f) cgi.

10. The method of claim 1, wherein the received user interface is sent by an operator utilizing a remote command element at a remote location

11. The method of claim 1, wherein the user interface controls content displayed on the one or more health stations.

12. A method, comprising:
establishing one or more communication sessions between one or more health stations and a web server;
receiving, at the one or more health stations, a response, from the web server, to update a host application stored on the one or more health stations;
establishing one or more additional communication sessions between one or more health stations and a file server;
receiving, at the one or more health stations, an updated host application, from the file server; and
loading the updated host application by a controller application stored on the one or more health stations.

13. The method of claim 12, wherein the one or more additional communication sessions are initiated by the one or more health stations.

14. The method of claim 13, wherein the one or more additional communication sessions initiated by the one or more health stations allow the one or more health stations to receive the host application from the file server if the one or more health stations are located within a secure network comprising a firewall.

15. The method of claim 13, wherein the one or more additional communication sessions are initiated by the host application stored on the one or more health stations.

16. The method of claim 12, wherein the loading the host application by the controller application comprises:
deleting an old host application stored on the one or more health stations; and
loading the updated host application received from the file server.

17. The method of claim 12, wherein the loading the host application by a host application allows the one or more health stations to run continuously without shutting down.

18. The method of claim 12, wherein the host application is updated in response to new hardware installed on the one or more health stations.

19. The method of claim 12, wherein the response to update the host application is sent by an operator utilizing a remote command element at a remote location.

20. The method of claim 12, wherein the controller application controls the host application.

21. An apparatus, comprising:
a user interface operable to:
establish a communication session between a health station and a web server;
receive media; and
load the media;
a host application operable to:
establish an additional communication session between the health station and a file server;
receive an updated user interface from the web server;
load the updated user interface; and
control one or more biometric devices; and
a controller application operable to:
receive an updated host application from the file server; and
load the updated host application; and
a display operable to display the user interface.

22. The apparatus of claim 21, wherein the communication session is initiated by the user interface.

23. The apparatus of claim 21, wherein the one or more communication sessions initiated by the user interface allows the health station to receive the updated user interface from the web server if the health station is located within a secure network comprising a firewall.

24. The apparatus of claim 21, wherein the loading the updated user interface by the host application comprises:
deleting the user interface stored on the health station; and
loading the updated user interface received from the web server.

25. The apparatus of claim 21, wherein the loading the user interface by the host application allows the health stations to run continuously without shutting down.

26. The apparatus of claim 21, wherein the user interface is a selected one of group of user interfaces, the group consisting of:
a) a FLASH player; and
b) a web browser.

27. The apparatus of claim 21, wherein the loading the host application by the controller application comprises:
deleting the host application stored on the health station; and
loading the updated host application received from the file server.

28. The apparatus of claim 21, wherein the media is a selected one of group of media, the group consisting of:
a) a swf flash file;
b) an html file;
c) php;
d) asp;
e) javascript; and
f) cgi.

29. The apparatus of claim 21, wherein the updated user interface is sent by an operator utilizing a remote command element at a remote location.

30. The apparatus of claim 21, wherein the user interface controls content displayed on the health stations.
